(19) United States
(12) Patent Application Publication
(10) Pub. No.: US 2025/0162592 A1
(43) Pub. Date: May 22, 2025

(54) ROAD QUALITY MONITORING

(71) Applicant: TECK RESOURCES LIMITED, Vancouver (CA)

(72) Inventors: Aliakbar Soleymani Koohbanani, Vancouver (CA); Mohammad Tabesh, Vancouver (CA); Carlos Viejo, Vancouver (CA); Mohammad Babaei, Vancouver (CA); Andreas Weber, Vancouver (CA)

(73) Assignee: TECK RESOURCES LIMITED, Vancouver (CA)

(21) Appl. No.: 18/834,580

(22) PCT Filed: Jan. 31, 2023
(86) PCT No.: PCT/CA2023/050132

§ 371 Date: Jul. 30, 2024

Related U.S. Application Data
(60) Provisional application No. 63/305,025, filed on Jan. 31, 2022.

(51) Int. Cl. B60W 40/06; G07C 5/00

(52) U.S. Cl. CPC B60W 40/06; G07C 5/008; B60W 2510/22

(57) ABSTRACT

A road quality monitoring system is able to identify and display to end users, e.g. dispatchers and supervisors, road segments that are in need of repair. Each road segment may be given a road quality score based on suspension loading data, such as strut pressure data, from trucks traversing the road segment or by launch velocity data from trucks leaving a mine site, such as a shovel or a dumping zone.

### RELATED APPLICATIONS

This application is the U.S. national stage of International Patent Application No. PCT/CA2023/050132 filed Jan. 31, 2023, which claims the benefit of and priority to U.S. Provisional Patent Application No. 63/305,025, titled ROAD QUALITY MONITORING, filed Jan. 31, 2022, both of which are incorporated by reference herein in their entireties.

### TECHNICAL FIELD

The present disclosure relates to a road quality monitoring system in a mine operation, and in particular to a road quality monitoring system which monitors vehicle and provides output indicative of the condition of road segments.

### BACKGROUND

An open pit mining operation requires a plurality of shovels for digging up the raw material, a plurality of loaders for loading the raw material onto trucks, and a plurality of trucks for transporting the raw material to a breaker for initial processing of the raw material.

A dispatcher is the quarterback of a mine site, responsible for impacting multiple key performance indicators (KPI's) throughout day-to-day operations. Typically, the dispatcher is trying to monitor several different computer screens and several different 3rd party applications, while communicating with multiple phones and radios.

A pit supervisor is often out in the field managing the operation on the ground. For large mining sites there may be several pit supervisors managing different sections of the mining site. Each pit supervisor shares some KPI's with dispatchers, but they are also accountable for things like safety and personnel issues in their section of the pit. Each pit supervisor may drive a vehicle around the mine site, and is often responsible for geographically separate equipment. Typically, each pit supervisor has access to a mobile phone and sometimes a laptop in the vehicle, but needs to pay attention to their surroundings at all times.

An object of the present disclosure is to provide a system for monitoring road quality in the mine and providing a list of alerts based on vehicles operating outside desired parameters resulting in a loss in production and a performance gap.

### SUMMARY

An example method of monitoring road quality in a mining operation performed by a plurality of different types of vehicles including a plurality of trucks travelling a plurality of roads, the method comprising: a) receiving vehicle operation data from the plurality of trucks, the vehicle operation data comprises strut pressure data and location data from the plurality of trucks; b) dividing the plurality of roads into a plurality of road segments; c) determining a road quality score based on the strut pressure data for a plurality of road segments; d) displaying the plurality of roads on a map; e) displaying road segments with the road quality score above a predetermined threshold value differently than road segments with the road quality score below the predetermined threshold value.

In some embodiments, the road quality score is also based on a number of times the road segment is travelled by the plurality of trucks.

In some embodiments, the road quality score is 0 when the number of times the road segment is travelled is below a travel threshold.

In some embodiments, the road quality score is based only on strut pressure data from trucks with at least a 50% load.

In some embodiments, the road quality score is based only on strut pressure data from rear axles of the plurality of trucks.

In some embodiments, the road quality score is based on strut pressure data normalized for truck speed.

In some embodiments, the road quality score is based on strut pressure data normalized for different types of trucks and strut pressure sensors.

In some embodiments, the road quality score is based on a mean road quality score over a given period of time.

In some embodiments, the road segments with the road quality score above a predetermined threshold value are displayed in a first color, while the road segments with the road quality score below the predetermined threshold value are displayed in a second different color.

In some embodiments, in step a) the vehicle operation data also includes velocity of the plurality of trucks; and step c) also comprises determining a road quality score based on launch speeds of the plurality of trucks from a stop.

In some embodiments, the launch speed is determined within an initial 200-400 meters from the stop.

In some embodiments, step e) also includes displaying road segments with a current launch speed different than an average previous launch speed by more than a predetermined threshold differently than road segments with a current launch speed different than an average previous launch speed by less than the predetermined threshold.

In some embodiments, the predetermined threshold is 2 km/h.

In some embodiments, the method comprises displaying obstacles on the map.

In some embodiments, the method comprises removing vehicle operation data from outlier vehicles.

In some embodiments, the outlier vehicles comprise trucks that produced less records than a daily threshold during the past predetermined time period.

In some embodiments, the outlier vehicles comprise trucks that produced average daily strut pressure data outside of a predetermined range.

In some embodiments, the outlier vehicles comprise trucks of a make or model that is not a selected make or model.

In some embodiments, the plurality of trucks include at least one autonomous truck; and further comprising providing a local area speed limit (LASL) system based on the road quality scores in the local area.

In some embodiments, each road segment is 50 m to 250 m in length.

Methods according to the present disclosure may include the foregoing features in operable combinations.

An example system for measurement of a road network in a mine comprises: a plurality of sensors installed at each of a plurality of vehicles on the road network and configured to acquire a sequence of suspension loading records for each of said plurality of vehicles, each comprising positioning coordinates of the vehicle and a measurement of load on vehicle suspension at a point in time; a processing device configured to: for each of said plurality of vehicles: receive said sequence of suspension loading records; detect variations in said load between ones of said sequence of suspension loading records; and associate each of said variations with one of a plurality of segments of said road network based on said positioning coordinates; and determine a road quality measurement representative of a condition of said segment based on said variations; and output on a user interface a graphical representation of said road network, said graphical representation including visual indicators of segments to be repaired.

In some embodiments, the measurement of load comprises a pressure in a vehicle strut.

In some embodiments, the processing device is configured to detect variations by computing a load on a rear suspension and compute a difference in said load on a rear suspension between successive suspension loading records.

In some embodiments, the processing device is configured to compute a vehicle-adjusted variation for each of said variations based on characteristics of the respective vehicle, and to determine said road quality score using the vehicle-adjusted variation.

In some embodiments, the processing device is configured to compute a velocity-adjusted variation for each of said variations based on a measured velocity of the respective vehicle, and to determine said road quality measurement using the velocity-adjusted variation.

In some embodiments, the processing device is configured to compute said velocity-adjusted variation by computing a normalized velocity and subtracting said normalized velocity from said variation.

In some embodiments, the processing device is configured to define a plurality of segments of said road network by dividing said road network into segments of a desired length.

In some embodiments, the processing device is configured to define said plurality of segments by plotting paths between road beacons using a smoothing algorithm.

In some embodiments, the processing device is configured to compute a count of traffic on each said plurality of segments.

In some embodiments, the processing device is configured to compute a quality score for each of said plurality of segments, said quality score based on said road quality measurement and said count of traffic, and said quality score for each segment representing a priority for that segment to be repaired.

In some embodiments, the processing device is configured to output on said user interface visual indicators of said quality scores for said segments.

Systems according to the present disclosure may include the foregoing features in operable combinations.

An example method for measurement of a road network in a mine comprises: obtaining a sequence of suspension loading records for each of a plurality of vehicles on the road network, each suspension loading point comprising positioning coordinates of the vehicle and a measurement of load on vehicle suspension at a point in time; for each of said plurality of vehicles: receiving said sequence of suspension loading records; detecting variations in said load between ones of said sequence of suspension loading records; and associating each of said variations with one of a plurality of segments of said road network based on said positioning coordinates; and determining a road quality measurement representative of a condition of said segment based on said variations; and outputting on a user interface a graphical representation of said road network, said graphical representation including visual indicators of segments to be repaired.

In some embodiments, the measurement of load comprises a pressure in a vehicle strut.

In some embodiments, the method comprises detecting variations by computing a load on a rear suspension and computing a difference in said load on a rear suspension between successive suspension loading records.

In some embodiments, the method comprises computing a vehicle-adjusted variation for each of said variations based on characteristics of the respective vehicle, and determining said road quality score using the vehicle-adjusted variation.

In some embodiments, the method comprises computing a velocity-adjusted variation for each of said variations based on a measured velocity of the respective vehicle, and determining said road quality measurement using the velocity-adjusted variation.

In some embodiments, the method comprises computing said velocity-adjusted variation by computing a normalized velocity and subtracting said normalized velocity from said variation.

In some embodiments, the method comprises defining a plurality of segments of said road network by dividing said road network into segments of a desired length.

In some embodiments, the method comprises defining said plurality of segments by plotting paths between road beacons using a smoothing algorithm.

In some embodiments, the method comprises computing a count of traffic on each said plurality of segments.

In some embodiments, the method comprises computing a quality score for each of said plurality of segments, said quality score based on said road quality measurement and said count of traffic, and said quality score for each segment representing a priority for that segment to be repaired.

In some embodiments, the method comprises comprising outputting on said user interface visual indicators of said quality scores for said segments.

Methods according to the present disclosure may include the foregoing features in operable combinations.

Other aspects will be apparent from the following detailed description and drawings.

### BRIEF DESCRIPTION OF THE DRAWINGS

Some example embodiments will be described in greater detail with reference to the accompanying drawings, wherein:

FIG. 1A is a schematic diagram of a mining operation;

FIG. 1B is a schematic diagram of a truck cycle in the mining operation of FIG. 1A;

FIG. 2A is a schematic diagram of a road quality monitoring system;

FIG. 2B is a block diagram of a telemetry system;

FIG. 2C is a flowchart of an example method of monitoring road quality;

FIG. 3 is a map generated by the road quality monitoring system of FIG. 2;

FIG. 4 is a schematic diagram a grade calculation for a road segment;

FIG. 5 illustrates an example range of data for determining vehicle outliers;

FIG. 6 is a display of a Haul Analytics page of the road quality monitoring system of FIG. 2;

FIG. 7 is a zoomed in view of the map from the Haul Analytics page of FIG. 6;

FIG. 8 illustrates a display from a local area speed limit (LASL) system;

FIG. 9 illustrates a display from an obstacle identification system;

FIG. 10 is a zoomed in view of the map from the obstacle identification system of FIG. 9;

FIG. 11 is a display of a metrics pane of the road quality monitoring system of FIG. 2;

FIG. 12 is a display of a road quality chart of the road quality monitoring system of FIG. 2;

FIG. 13 is a display of a speed loaded/empty chart of the road quality monitoring system of FIG. 2;

FIG. 14 is a display of a shovel launch speed chart of the road quality monitoring system of FIG. 2;

FIG. 15 is a display of a dump launch speed chart of the road quality monitoring system of FIG. 2; and

FIG. 16 is a display of a zoomed in view of the map of the road quality monitoring system of FIG. 2 illustrating a road segment from the dump launch speed chart.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

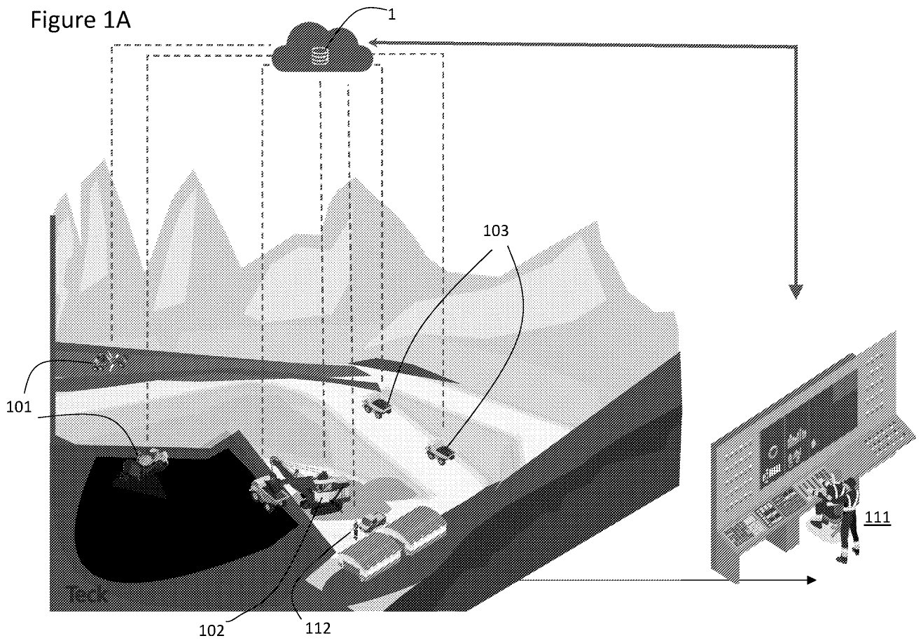

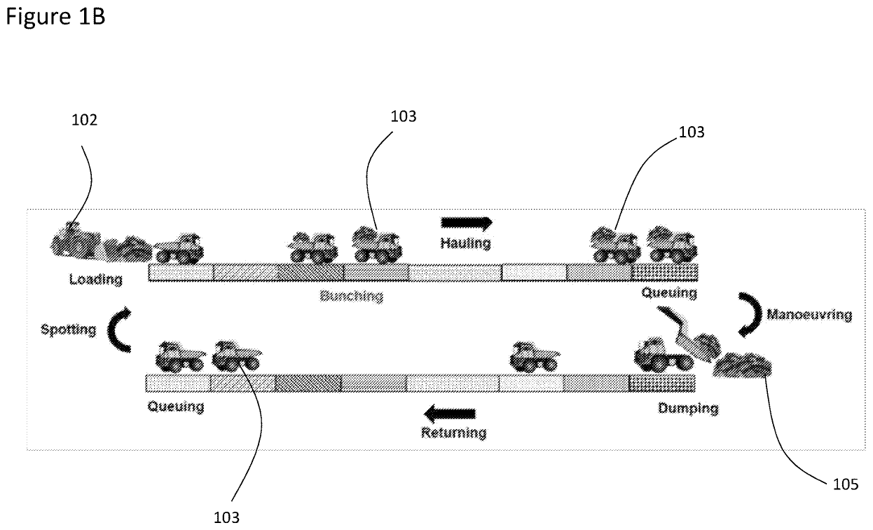

With reference to FIGS. 1A and 1B, an open pit mining operation includes a plurality of shovels and/or drills 101 for digging up the raw material, a plurality of loaders 102 for loading the raw material onto trucks 103, and a plurality of trucks 103 for transporting the raw material over a series of roads to one or more breakers for initial processing of the raw material.

A dispatcher 111 is the quarterback of a mine site, responsible for impacting multiple key performance indicators (KPI's) throughout day-to-day operations. Typically, the dispatcher 111 is trying to monitor several different computer screens and several different 3rd party applications, while communicating with multiple phones and radios.

A pit supervisor 112 is often out in the field managing the operation on the ground. For large mining sites there may be several pit supervisors 112 managing different sections of the mining site. Each pit supervisor 112 share some KPI's with dispatchers 111, but they are also accountable for things like safety and personnel issues in their section of the pit. Each pit supervisor 112 may drive a vehicle around the mine site, and is often responsible for geographically separate equipment. Typically, each pit supervisor 112 has access to a mobile phone and sometimes a laptop in the vehicle, but needs to pay attention to their surroundings at all times.

With reference to FIG. 1B, a typical cycle in a typical mining operation includes the shovels and/or drills 101 piling the material in a remote mining location, while the loaders 102 load the material onto a plurality of material handling (dump) trucks 103. Roads may be constructed throughout the mining operation, e.g. for transit of machinery such as trucks between locations. Over time, the condition of such roads may deteriorate due to traffic, weather and other factors.

The trucks 103 may take time in transit and getting into position for loading, then they may bunch up during hauling and queueing while waiting to dump their load at a dumping site 105, e.g. a breaker. The trucks 103 may also take time in transit and getting into position for dumping. After dumping their load, the trucks 103 then return to the loading site, which again may result in bunching and queuing delays, thereby completing the cycle. All of these steps may cause a loss of production. The condition of roads within the mining operation may influence the speeds at which trucks can safely travel. For example, worn, uneven or slippery road conditions may force trucks to reduce speed. Such speed reductions may likewise adversely impact production. In addition, poor road conditions may adversely impact safety. Accordingly, it may be desired to monitor road condition and perform upkeep of roads within the mine. However, road maintenance may be costly, as personnel and machinery are required to perform maintenance. In addition, performance of maintenance may potentially force closures of roads. Therefore, identification of areas in need of upkeep and allocation of resources to those areas may be important for efficient operation.

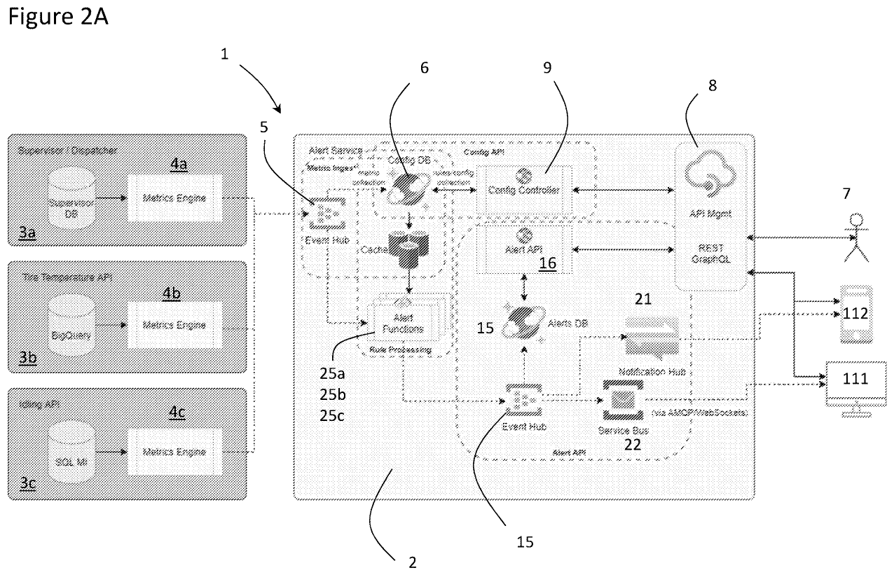

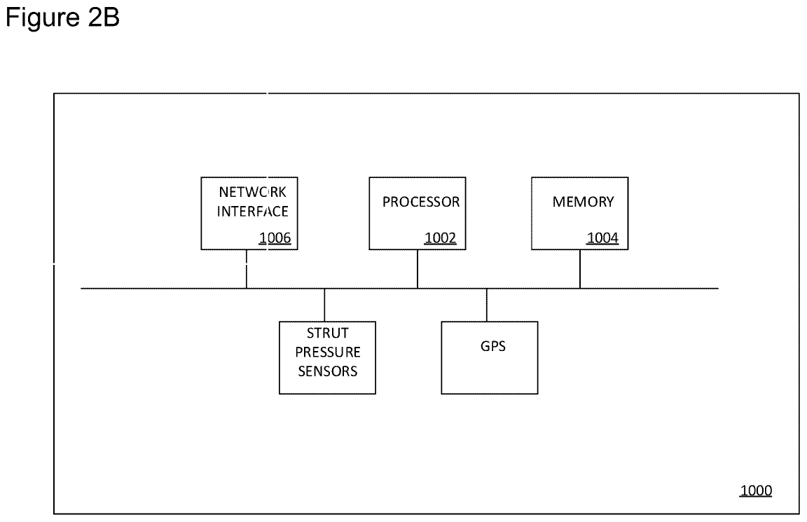

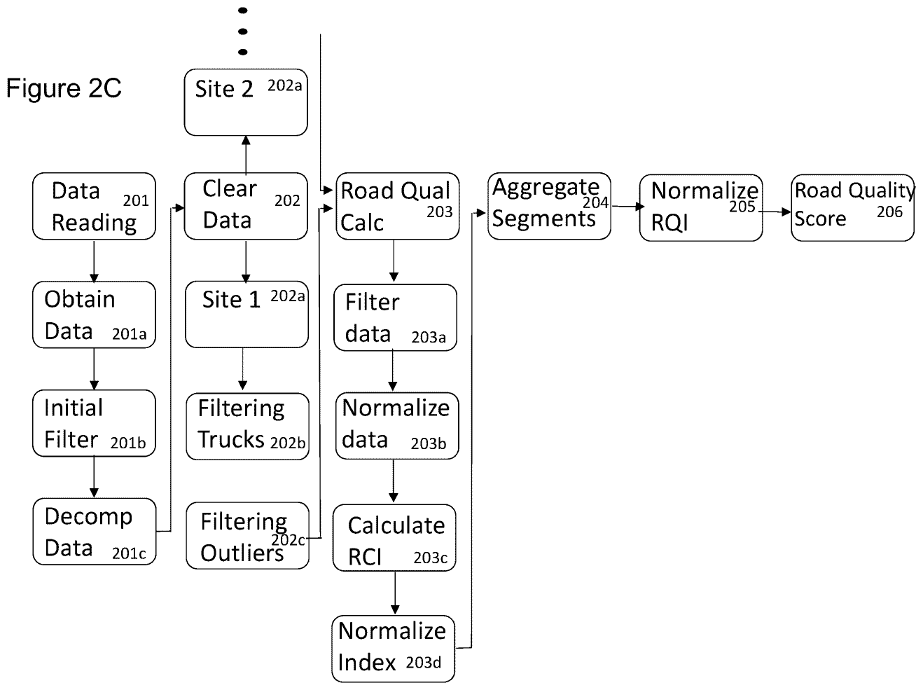

FIG. 2A depicts an example road quality monitoring system 1. With reference to FIG. 2, a road quality monitoring system 1 comprises a controller processor 2 executing computer instructions stored on non-transitory memory, e.g. local or cloud based. The road quality monitoring system 1 further includes telemetry systems 1000 at vehicles and machinery such as trucks 103 and one or more databases. In the depicted example, the databases may include a roads database 3a and a vehicle history database 3b. Telemetry systems 1000 transmit vehicle operation data which may be processed and stored in the databases. Roads database 3a includes spatial definitions of roads within a mine. The roads may be represented as series of coordinates such as global positioning system (GPS) coordinates. In an example, the coordinates are defined based on manually defined beacons spaced apart along the roads. Road portions between the beacons may be computed for example by line fitting or curve fitting between the beacons, and applying a smoothing algorithm to the resulting curves.

Vehicle history database 3b includes, for each vehicle operating in the mine, a series of position measurements such as GPS coordinates, with corresponding vehicle status measurements. For example, for each vehicle, the status measurements may include measurements of strut pressures at each wheel. Each set of GPS coordinates and corresponding strut pressure measurements may be associated with one another, e.g., by a time stamp identifying the time at which the measurements were made.

FIG. 2B depicts an example telemetry system 1000 in greater detail. Telemetry system 1000 includes a computer with memory 1004, a processor 1002, network interface 1006, and is interconnected to a variety of sensors. The sensors may include, for example, a GPS sensor, sensors integrated with or directly connected to the controllers such as electronic control units (ECUs) at the vehicle and other on-board sensors. In the depicted example, the sensors include strut pressure measurement sensors for measuring strut pressure at each wheel.

The processor 1002 may be an intel or AMD x86-based processor, or an ARM-based processor, or any other suitable processor.

Memory 1004 (e.g., RAM) includes a computer-readable storage space accessible by processor 1002 for storage of working data and code. Memory 1004 also includes persistent computer-readable storage containing instructions for execution by processor 1002 and for storage of data collected by the various interconnected sensors. Memory 1004 may include any one or more suitable memory types, such as flash memory, hard drives or the like.

Network interface 1006 may be any suitable wired or wireless device connecting the computer to a network for communication with a data host. Network interface 1006 may be, for example, an Ethernet or IEEE 802.11 (Wi-Fi) network adapter. Network interface 1006 may include an antenna for transmitting data, receiving data or both. In some embodiments, the network interface may include multiple antennas, such as antennas in a phased array, and may connect to a LAN or WAN using a steered beam.

Telemetry system 1000 may also be capable of uniquely identifying the shovel 101, loader 102 or truck 103 at which it is installed. For example, each telemetry system may identify its respective machine to other devices by way of network interface 1006. The telemetry system may also be capable of receiving operating instructions by way of network interface 1006. Such instructions may be implemented automatically, e.g. by autonomous machinery, or provided to an operator, e.g. via a display. Received instructions may, for example, include assignments of a truck 103 to a specific shovel, loader, loading zone or unloading zone.

Processor 1002 may read values from the interconnected sensors at defined frequencies. For example, the processor 1002 may read a value from each sensor every 2 seconds. However, in other embodiments, the frequency may be higher or lower. In some embodiments, different sensors may be sampled at different frequencies. In general, it may be preferable to sample at the highest frequency supported by each sensor, subject to data processing and transmission bandwidth constraints. Processor 1002 may transmit measurements via a suitable communication network. Road quality monitoring system 1 determines whether the received data meet any of the criterion needed to be sent as alerts to personnel on site. The data may include vehicle operation data, such as GPS, speed, tire temperature, fuel consumption, load weights, strut pressure, and even weather, and production data of material processed from the one or more breakers or the trucks 103. A set of sensor data from a particular vehicle at a particular point in time may be referred to as a suspension loading point. A suspension loading point may include, for a vehicle at a specific point in time, positioning coordinates such as GPS coordinates, and suspension loading data, such as strut pressure on vehicle struts. Additional data may be included, as will be appreciated. Each telemetry system 1000 acquires and transmits for storage in database 3b a sequence of suspension loading records.

Vehicle operation data from databases 3a, 3b may be processed and converted into Key Performance Indicators (KPI) by corresponding metrics engines 4a, 4b. Data in the form of Key Performance Indicators and their actual/expected values may be stored in data tables in each site's memory database 6. The road quality monitoring system 1 may regularly poll each memory databases 3a, 3b and 6 for new data via event hub 5, and once found will process the data to determine new alerts. The site memory database 6 may be loaded and updated by an end user 7, e.g. management, via a management API 8 and config controller 9. The different KPI, KPI thresholds and types of alerts may be stored on an alert database 15 via an alert API 16 and/or the management API 8 by an end user 7, e.g. management.

The controller processor 2 may also generate and send one or more notifications to overcome the causes of the confirmed alerts along with the prioritized list of confirmed alerts with improved or optimal configuration parameters based on historical, current and planned configurations. Pit supervisors 112 and dispatchers 111 receive real time action notifications to optimize the system. Throughout the shift, dispatchers 111 and supervisors 112 receive automated alerts, personalized to their role, that focus them on the highest impact actions.

With the road quality monitoring system 1, the quality (i.e., condition) of the roads in a mining site are monitored to determine how the road quality impacts the speed of trucks and therefore mine production over time. The road quality metrics includes a Road Quality Index and a Road Quality Score for road segments and locations of the shovels 101. The Road Quality Index may be a measure of a change in consecutive values of suspension loading (e.g., strut pressure) of each truck 103, i.e., a variation in suspension loading between consecutive suspension loading records. Which may be normalized by speed, acceleration, and truck fleet (strut pressure measuring systems), and by how far each data point is from an average or “mean” value for the trucks 103 travelling in the mine, which may be a set predetermined value based on historical data or a dynamic value based on historical data plus constantly updated data, as the data is generated.

Because of the added weight of each payload, the vehicle data, e.g. strut pressure, from only the loaded trucks 103 may be used to calculate the Road Quality Index. The telemetry system 1000 of each truck and the road quality system 1 monitors the strut pressure value difference in time. Values may be corrected for speed and acceleration, and the location corresponding to each value, e.g. which segment of which road, is determined via GPS readings. The road segment where the changes of the strut pressure are registered is then considered as a problematic point.

The Road Quality Index is a measure of the state of a corresponding Road Segment based the strut pressure data that comes from the trucks 103. Higher Road Quality index is indicative poorer road quality. In other words, road quality index is representative of the condition of the corresponding road segment, with higher road quality index indicating poorer condition. The Road Quality Index may then be used to calculate the Road Quality Score. The Road Quality Score may be calculated differently for the road segments and locations of shovels 101.

For road segments, the Road Quality Score calculation may be determined by factoring in the Road Quality Index and traffic, e.g. count of trips or cycles within a given time period. In an example, the time period may be three hours. However, the time period may be shorter or longer depending on the amount of traffic on the road network. For example, a shorter period may be used for roads which experience a large amount of traffic and a longer period may be needed for roads which experience less traffic. A higher priority may be given to the Road Segments with higher traffic and higher index, i.e. with poor road quality. If the Road Quality Score is greater than a threshold that is configured for the Mine, the Road Segment may be marked as critical (red) or non-critical (yellow). A max number of critical Road Segments may also be configured per mine site to ensure that only the most severe and high-traffic road segments are identified as critical.

FIG. 2C depicts an exemplary method for road quality monitoring system 1 to determine the road quality of one or more road segments in a mining site.

At step 201, road quality monitoring system 1 reads vehicle operating data from database 3b. Generally, step 201 includes obtaining data (step 201a), initial filtering of data (step 201b) and decompressing of data (step 201c). Data may only be obtained for a specific time window, such as a 30 minute, 2 hour or 3 hour time window.

At step 201a, data is obtained by road quality monitoring system 1 from database 3b. Data includes vehicle operating data, such as a series of GPS locations for each vehicle with associated time stamps and strut pressure readings from each strut. Road quality monitoring system 1 may also read other data in addition to vehicle operating data. As well, data may be obtained directly from the vehicles, such as trucks 103, or from fleet management systems that are in direct communication with trucks 103.

Additional data may be derived from the vehicle operating data. For example, vehicle velocity and acceleration may be computed at each time stamp, based on GPS locations at that time stamp and previous time stamps. Additionally, strut pressure changes may be computed based on differences between successive strut pressure readings. Strut pressures may also be averaged. For example, in some embodiments, four strut pressure readings may be received, such as front left, front right, rear left and rear right strut pressures. An average of the front strut pressures, and an average of the rear strut pressures may be computed, as well as an average of all four strut pressures.

At step 201b, data is initially filtered by road quality monitoring system 1, such as to remove outlier data from vehicles based on their coordinates. For example, some data may pertain to vehicles operating in sites that are not being monitored or may be associated with a GPS error. Accordingly, each set of GPS points may be tested for proximity to a known road. For example, an orthogonal distance from each GPS point to the nearest road may be calculated, and points with orthogonal distance over a threshold value may be discarded, along with the associated strut pressure values.

In some embodiments, data transmitted from vehicles, or other data transmitted within road quality monitoring system 1 may be compressed. For example, in order to conserve bandwidth, some data obtained by road quality monitoring system at step 201a may be compressed using one or more compression algorithms. For example, data may be sampled or recorded at a predetermined interval but only changed values may be transmitted, such that some values may be missing. In an example, data may be sampled at 2 second intervals and transmitted when there is a change relative to the previous measurement. At step 201c, data is decompressed by road quality monitoring system 1, such that road quality monitoring system 1 may populate or forward fill absent values in data in order to minimize the effects of data compression.

At step 202, road quality monitoring system 1 clears data. Clearing data 202 includes separating data by a specific mining site or area (step 202a), filtering data for a specific vehicle type (step 202b) and filtering data to remove outliers (step 202c).

At step 202a, road quality monitoring system 1 separates data by a specific mining site or area. Data obtained at step 201a may include data from multiple mining sites or multiple areas within a single mining site. Data may be segregated for each site or each area. Such segregation may, for example, be performed based on GPS location. For example, polygons may be defined representing each site and each area, and data may be grouped based on the polygon or polygons each GPS point fits into. Segregation of data in this manner may allow a subset of areas within a mining site to be prioritized for maintenance, so that a Road Quality Score may only be determined for those areas, or so that score for those areas may be addressed before those for other areas.

At step 202b, road quality monitoring system 1 filters data for a specific vehicle type, such as a specific make or model of trucks 103. For example, road quality monitoring system 1 may filter to only retain data related to a truck from a first manufacturer or for a specific model of truck. Road quality monitoring system 1 may also filter data for multiple vehicle types, such as filtering to only retain data related to a subset of truck types, or filtering to only retain data for one of trucks, shovels or loaders.

It will be appreciated that road quality monitoring system 1 may filter for a specific vehicle type at step 202b based on the specific mining site or mining area used to separate data at step 201a. For example, one mining site may only include trucks from a first manufacturer, while another mining site may only include trucks from a second manufacturer.

At step 202c, road quality monitoring system 1 performs additional filtering to remove outliers from data obtained at step 201a. For example, strut pressure data may be filtered based on vehicle velocity. That is, strut pressure values associated with velocity values below a minimum threshold or above a maximum threshold may be eliminated. For example, velocity values exceeding 65 km/h may be eliminated. Moreover, strut pressure data that exceeds or is below an acceptable threshold may also be filtered and removed from the data. For example, strut pressure values below 10 kg/cm2 or exceeding 270 kg/cm2 may be filtered and removed from the data. Filtering may eliminate readings from faulty trucks or trucks with faulty sensors. In some embodiments, step 202c may be executed before steps 202a and 202b, such as to filter out faulty truck data at first instance.

At step 203, road quality monitoring system 1 calculates a Road Quality Index (RQI) based on data cleared at step 202. Step 203 includes filtering data from trucks 103 that do not have a load (step 203a), normalizing data (203b), calculating an uncorrected RQI (step 203c), and correcting the uncorrected RQI (step 203d).

At step 203a, road quality monitoring system 1 filters data from trucks 103 that do not have a load. In some embodiments, data may be filtered to remove data from trucks 103 with a load below 50% or 75% of the average load. Such filtering may be done based on strut pressure readings. As will be appreciated, suspension behaviour in vehicles may vary based on vehicle type and load. For example strut pressures of unloaded trucks may be lower than those of loaded trucks. In addition, transient suspension behaviour on an uneven road may differ between unloaded and loaded trucks. Filtering may for example be performed by defining threshold readings, such as a threshold mean strut pressure value for each type of truck 104. It will be appreciated that step 203a may also include determining the average load of trucks 103 in data.

As well, front axle strut pressure readings may also be removed from data, such that only rear axle pressure readings may be used to compute the RQI. In some embodiments, a sum of the left and right strut pressures from the rear wheels may be used to obtain a composite or total rear axle pressure.

At step 203b, road quality monitoring system 1 normalizes data. For example, strut pressure data may be normalized using a scale factor based on the type of vehicle from which the data was recorded. Various scale factors may be determined experimentally, such that each truck's scale factor may be used to scale its strut pressure to be comparable to the normalized strut pressure data from any other truck. Scale factors may also depend on the type of sensors used to record the strut pressure data. In some embodiments, a table of scale factors may be developed from testing and experience to normalize strut pressure data from different types of trucks and different types of sensors. In an example, the scale factors range from 0.9 to 1.2. Strut pressures normalized in this manner, and pressure changes computed from such normalized strut pressures, may be referred to as “vehicle-adjusted”.

At step 203c, road quality monitoring system 1 calculates an uncorrected RQI. The uncorrected RQI may be calculated by determining the total rear axle strut pressure and subtracting the previous total rear axle strut pressure. The previous total rear axle strut pressure may be associated with previous data obtained by road quality monitoring system 1. In other embodiments, the uncorrected RQI may be calculated by determining the total rear axle strut pressure and subtracting an average total rear axle strut pressure across a plurality of trucks 103. It will be appreciated that although the total rear axle strut pressure is used in step 203c, all values were normalized using a scale factor in step 203b.

Suspension behaviour, such as strut pressure, may depend on a vehicle's velocity. For example, the magnitude of force applied to a strut upon encountering a bump (and thus, the strut pressure) may be proportional to velocity. Accordingly, at step 204d, road quality monitoring system 1 corrects the uncorrected RQI for velocity. Step 204d includes determining a standardization term with which to correct the uncorrected RQI. For example the standardization term may be based on the speed of the truck, which may be estimated based on GPS data from the truck. Strut pressures may also be impacted by acceleration. For example, under positive acceleration, a vehicle's weight may shift rearwardly, causing the vehicle to “squat” and applying a force to the rear suspension. In some embodiments, an acceleration value may also be computed from the GPS speed estimation. Data samples with acceleration above a threshold value (e.g. >3.6 m/s2) may be filtered out to eliminate strut pressure variation that is due to acceleration rather than road roughness. GPS speed for the time window under consideration may then be converted to normalized values within a defined range using a standardization technique, such as by subtracting a mean speed and dividing by the standard deviation of the speed. In an example, strut pressures may be measured in kg/cm2 and velocities may be converted to normally-distributed values between −10 and 10. Typical strut pressures may depend on the specific truck, the specific strut on that truck and whether/how much the truck is loaded. For example, typical strut pressures may be between 10 and 270 kg/cm2. The raw or vehicle-adjusted RQI may be adjusted for velocity by subtracting the normalized velocity from the raw or vehicle-adjusted RQI. The resulting value may be referred to as “velocity-adjusted”. That is, a relatively high velocity, corresponding to a positive normalized velocity, may be subtracted such that the velocity-adjusted RQI is lower than the RQI without velocity adjustment. Conversely, a relatively low velocity, corresponding to a negative normalized velocity, may be subtracted such that the velocity-adjusted RQI is higher than the RQI without velocity adjustment.

Step 204d also includes correcting the uncorrected RQI with the standardization term. In some embodiments, the standardization term may be subtracted from the uncorrected RQI. For example, the corrected RQI formula may be:

RQIcorrected=RQIuncorrected−Standardization Term

It will be appreciated that, in some embodiments, the speed of the truck is not linearly related to the total rear axle strut pressure of the truck. As such, the corrected RQI may be based on an approximation of this non-linear relationship between rear axle strut pressure and speed, such that the standardization speed (based on speed) may be subtracted from the uncorrected RQI (based on rear axle strut pressure).

In further embodiments, an additional bias term may be subtracted from the uncorrected RQI, such as to scale or shift data for better presentation in a user interface or for easier analysis. For example, the corrected RQI formula may be:

$$RQIcorrected = RQIuncorrected - Standardization Term - Bias$$

An exemplary bias term may equal 50, although other values are possible depending on, for example, the user interface, the scale factors used at step 203b and other factors.

In still further embodiments, one or both of the standardization term and bias may instead be used to scale the uncorrected RQI, such as in a further normalization step.

At step 204, road quality monitoring system 1 combines the corrected RQI with map data. For example, a map file, such as a GeoJSON file, may represent the mining site or areas within the mining site, and may include data describing road segments within the mining site or areas. The map file may be used to correlate the RQI data with the corresponding road segments included in the map file.

In some embodiments, each road segment may be associated with a set of calculated data including one or more of the following: a mean RQI per segment; a max RQI per segment; a min RQI per segment; a count column (number of records) per segment; a truck count per segment; and a haul cycle count per segment, e.g. number of times or number of cycles (back and forth) that a truck travels the segment in question.

At step 205, road quality monitoring system 1 generates a final RQI value for each segment. The final RQI value may be generated by calculating a mean RQI over a predetermined time interval, e.g. every 30 minutes to 6 hours, preferably every 2-4 hours, or more preferably every 3 hours.

An overall Road Quality Score (RQS) may be calculated by road quality monitoring system 1 at step 206 using the final RQI generated at step 205. The RQS may reflect prioritization of the associated road segment for remedial work. That is, a road segment with a high RQS may have higher priority for remedial work than a road segment with low RQS. The RQS may be calculated based on the final RQI and the amount of traffic on the road segment so that higher-traffic segments are prioritized over lower-traffic segments of like road quality. For example, the RQS may be the product of the final RQI and the amount of traffic. The amount of traffic on the road segment may be determined based, e.g. on a cycle count of vehicles travelling on that road segment over the predetermined time interval, such as the time interval used at step 205.

In some embodiments, when the cycle count is less than a traffic threshold, such as 5 cycles, then the RQS is immediately set to 0, despite a corresponding non-zero RQI. In further embodiments, the RQS may use the amount of traffic as a multiplier to scale the final RQI and obtain the RQS, such as by multiplying the final RQI by the cycle count.

For Shovel location, the Road Quality Score may be calculated by using a launch speed of trucks 103 as they depart from stopping at a mine location, e.g. from a shovel 101. The launch speed may be determined while the truck is at a predetermined distance from the shovel 101, e.g. in the first 100-200 meters, preferably about 150 meters. The launch speed may be an average launch speed for trucks 103 in a predetermined time period, e.g. every 20-60 minutes, preferably 30 minutes. If the difference between the current launch speed and the previous launch speed is more than a predetermined threshold, e.g. 2 km/h, the shovel 101 (and its location) may be marked as critical (red).

The data source providing vehicle data for determining the Road Quality Score metrics may include one or more of the following systems:

A mining equipment maintenance (MEM) system providing vehicle sensor data from Trucks, Shovels, and other vehicles regarding engine, temperature, GPS coordinates, and suspension (namely, GPS speed (km/h) and strut pressure (kg/cm2).) The vehicle sensor data may be collected at a desired time interval, e.g. less than about every 10 seconds, preferably less than about every 5 seconds, more preferably about every two seconds. Because the vehicle sensor data may be collected from a plurality of the trucks 103, preferably a majority of the trucks 103, and more preferably almost all of the trucks 103 in the mine, the road quality monitoring system 1 may be able to show the state of each road segment used in the mine based on the average data from the trucks 103; and

A fleet management system providing production and operations data, including information about what the trucks 103 are doing and what they should do next. The fleet management system may be used by the mining site Dispatchers.

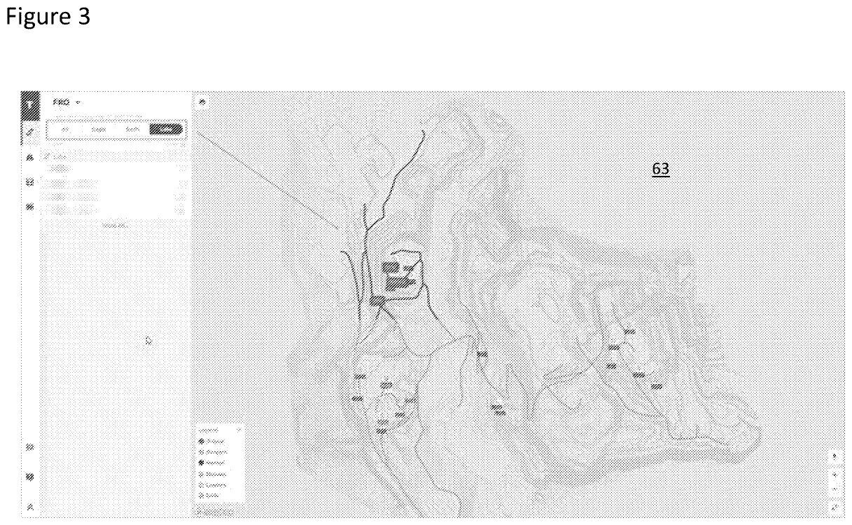

With reference to FIG. 3, to generate a map 63 of the road network in the Road Quality monitoring system 1, a GeoJSON file or other suitable software application may be used. GeoJSON is a format for encoding a variety of geographic data structures. The mapfile may be generated once or more times a day, depending on the mine configuration. Conventional and autonomous fleets may share common algorithms to generate the map file and the road network. To generate the map file, the Road Quality monitoring system 1 may perform the following steps:

1. Read the system data with roads (the “connected points”) from a proper system, and then perform splitting to get the desired Road Segment length. The road data is queried from a Road Segments BigQuery (BQ) table. Based on the type of the Mine, one or more MEM systems and fleet management systems may be used.

2. Generate the map file (e.g. GeoJSON file) with the specific Road Segment length for each Mine, e.g. 50 m to 250 m, preferably 50 m-150 m. The generated Road Segments may not be that exact length, and they may be bigger or smaller. For the majority of the Mines, each Road Segment may be assigned to a specific Pit. A Pit is an area that covers a part of the Mine. A user of the road quality monitoring system 1 may be able to switch between Pits to view them on the map. With reference to FIG. 3, a specific pit is selected for the mine and its area is highlighted on the map.

Map Matching is the process of matching a Truck's geoposition with the Road Segments on the road network of the site. Each MEM system (which includes data describing a strut pressure event) record can be uniquely identified by a timestamp when the sensor data was sent and an ID of a Truck that sent its geopositioning data. The road network is broken into multiple Road Segments. Each Segment has its own boundaries that are defined by geopositioning coordinates. The process thus comes down to iteratively comparing each of the MEM geopositioning records to each of Segment's bounds ‘box’, and then assigning a certain Segment ID to the (TIME_TWO_SEC, unit_id) set.

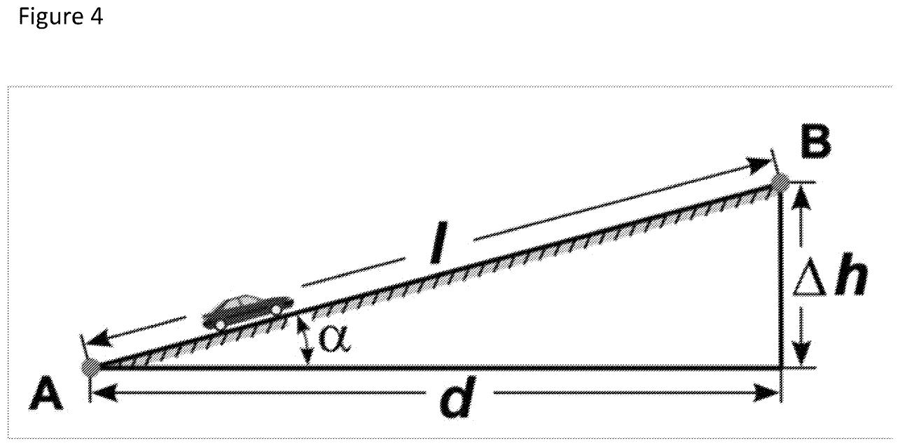

3. The grade of each road segment, i.e. information about the elevation on the Road Segment, may then be determined. The value in degrees refers to the tangent angle of the Road Segment surface to the horizontal line, as illustrated in FIG. 4. The grade value may be calculated by using a model of the road surface and x, y, and z coordinates of the beginning and ending of the Road Segment. The absolute value of the Grade may always be positive, e.g. 7.0% or 3.5%. A road segment may be designated as a ramp based on the Grade value, i.e. a grade value greater than a predetermined value, e.g. 5°.

Before calculating the Road Quality Index and Road Quality Score metrics, the road quality monitoring system 1 may run an algorithm to eliminate trucks 103 that return invalid data. To ensure only valid data is utilized by the road quality monitoring system 1, an algorithm eliminates trucks 103 with faulty data or other low-performing trucks 103. Such trucks 103 may not be included in the calculation of the Road Quality metrics and may be labelled as Outliers. To eliminate truck outliers, each day, the Road Quality monitoring system 1 may compare the data, e.g. strut pressure data, for each truck 103 to the previous week of data. In a day, a truck 103 is typically expected to produce around 43,000 records. To provide any significant data for the Road Quality metric, each truck 103 may need to produce the amount of records that equals at least half a day of work during the previous week.

Accordingly, the Truck Outliers are divided into two categories:

Faulty trucks—the truck 103 performs multiple cycles and its sensors send faulty (not valid) data, for example, 0 instead of a real value, more than a predetermined number of times, e.g. over 10%, preferably over 25%. In this case, the data from the truck 103 falls outside of the average for the group and may not be used for the Road Quality metric calculation.

Eliminated trucks—the truck sensors return no or not enough data and therefore it is not useful for statistical purposes. Each truck 103 generates a record every two seconds. For every mine, there is a threshold of the minimum amount of records that each truck 103 needs to produce for its data to be valid, otherwise it is omitted from input data to the model. The threshold configurations may be one or more of the following: more than 10,000 records, preferably more than 15,000 and more preferably more than 20,000 records.

The threshold is applied based on the following criteria: a) trucks 103 with such a small amount of records per day might have been broken, turned off, and directed to maintenance, so their sensors data could be invalid; and b) the amount of records is insufficient to find out whether sensors data was truly invalid or not, so that such trucks 103 are eliminated entirely.

The road quality monitoring system 1 may use the following logic to identify the truck outlier:

1. Each day, the data for each truck in a group is compared to the previous week or previous 3 days of data.

2. Trucks that produced less records than the mine daily threshold during the past week are omitted from input data to the model. For other Trucks:

A) For each Truck group, the average value of strut (suspension) pressure that was recorded for the previous week is calculated for each of the suspensions, e.g. front left, front right, rear left, rear right). The average value is a “mean” value. The previous 7 days of data may be taken to run the algorithm. Firstly, the data from the 6 days may be used to calculate the “fleet” average value of strut (suspension) pressure for each of four truck's sensors. Then, the data for the seventh day may be used to calculate the “Truck” average value of suspension pressure for each of four truck's sensors. Finally, each Truck average value may be compared with the corresponding trucks fleet value to calculate faulty trucks criteria.

B) For each individual truck 103, the previous week average of strut (suspension) pressure value may be calculated for each of the suspensions, e.g. front left, front right, rear left, and rear right. Then, the truck average value is compared to the corresponding fleet average value for each of four sensors. If these averages are outside of the +/−2 standard deviations of the group average, the truck 103 may be flagged as an Outlier.

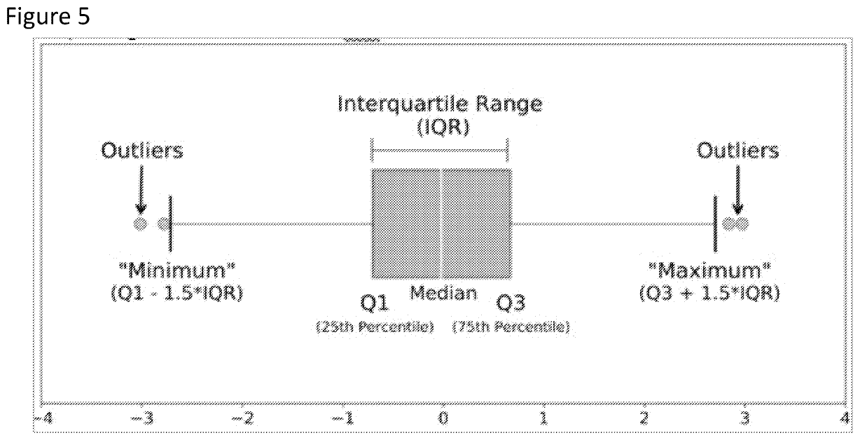

3. With reference to FIG. 5, another round of elimination may be carried out by comparing the average strut (suspension) pressure value of each individual truck 103 to the truck group by using the following criteria: −/+1.5*(Interquartile Range). If the truck (strut pressure) data falls outside of the group averages, then the corresponding truck 103 is identified as an Outlier. The data about the truck outliers may be stored in a database for display on the truck outliers report page.

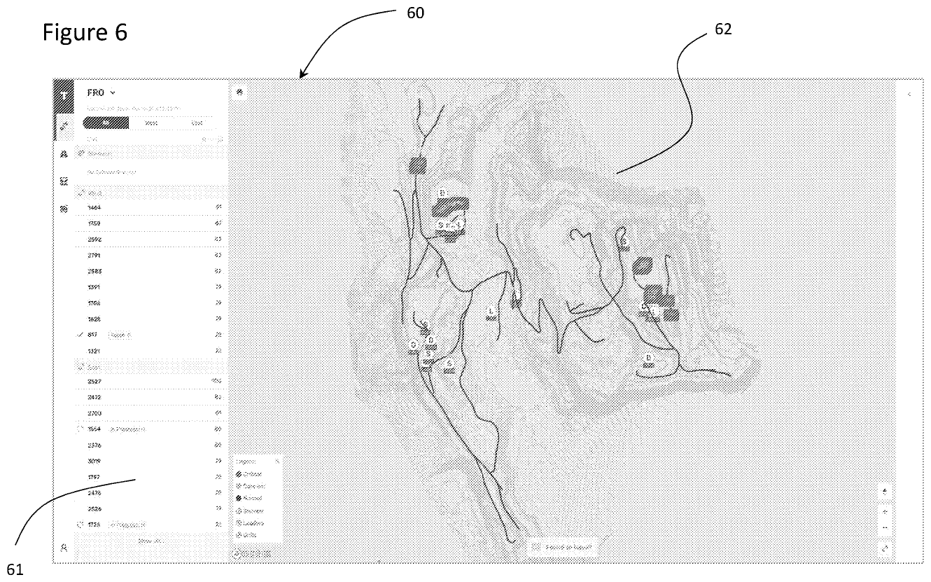

With reference to FIG. 6, the road quality monitoring system 1, via the controller processor 2, may be configured to display on a user's display screen a Haul Analytics page 60, which may include: 1) a left pane 61 with a list of vehicles, e.g. shovels 101, loaders 102, trucks 103 and drills; 2) a map 62 of the mine site (or pit) in which the road segments, in particular high scoring road segments, are illustrated; and c) a metrics pane 63, which when activated by the user may include details about selected road segments or shovels. Actions may be entered by the user or alerts dismissed by the user from the metrics pane. Ideally, somewhere on the haul analytics page 60, e.g. in the upper-left corner, the exact time when the latest updates were uploaded to the application is displayed.

The road segments with road quality scores over a predetermined threshold may be identified, as such, via color coding etc. A prioritized list of high-scoring road segments may also be generated and displayed by the road quality monitoring system 1, e.g. from highest to lowest road quality score. Moreover, the road segments with a road quality score over a first threshold level may be identified at a first level, e.g. moderate (yellow), and road segments with a road quality score over a second threshold level may be identified at a second level, e.g. urgent (red).

The shovels 101 may be prioritized as above by the road quality score into one or more levels of urgency (color coding) based on the speed of loaded trucks 103 as they depart from shovel 101. The pit supervisors 112 may be instructed by the road quality monitoring system 1 via an alert signal to their computer or smart device to take action on either the high scoring road segments or the high scoring shovels or dismiss alerts.

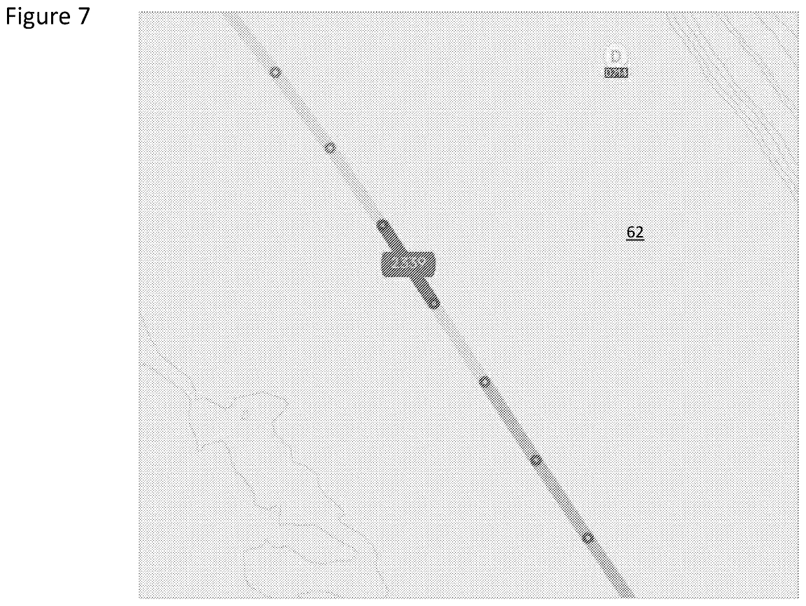

For each mine and/or pit, the road quality monitoring system 1 may display a map 62 with real-time positions of the shovels 101, the loaders 102, the drills and the trucks 103. The positions of the equipment may be updated after a desired time period, e.g. every 1 minute to 60 minutes, preferably every 5 minutes to 45 minutes, and more preferably every 15-30 minutes. The road segments may be color coded according to their road quality score and traffic. When a road segment or a shovel is selected from the unit list on the left pane 61 or directly from the map 62, the selected road segment may be highlighted on the map 62 and the metrics pane for the corresponding road segment may be displayed on the right side or a separate page. All road segments and the vehicles, e.g. the shovels 101 and the loaders 102, may be visualized on the map 62 with dynamic labels. In addition, the map 62 may show the position of the user, e.g. with a green dot, whereby the user may track their location related to the road segments or shovels. When a critical road segment or shovel is selected on the left pane 61, the map 62 may zoom in to display the selected road segment or shovel. The selected road segment may be highlighted, while all the other ones have faded color, as in FIG. 7.

The shovels 101 or the road segments beside shovels 101 may be color coded on the map 62 according to the following criteria: the shovel 101 appears as critical, e.g. with a first color (red) score on the left pane 61 and the first color (red) label in a (red) circle on the map 62, when the truck launch speed drop is >than a predetermined threshold, e.g. 2 km/h. The shovel 101 appears as non-critical second color (black) score on the left pane 61 and the blue label in blue circle on the map 62, if the Truck launch speed drop is <=the predetermined threshold, e.g. 2 km/h.

The road segments displayed on the left pane 61 may be sorted in a prioritized list by the road quality score and traffic. The road quality score calculation is determined by factoring in the road quality index and traffic, such as a count of unique truck cycles within the last predetermined time period, e.g. three hours. For example, if the road segment has a road quality index of 80, but there were less than 5 cycles during the last 2 hours, it is not marked as critical. The road quality score may be generated every predetermined time period, e.g. 30 minutes, using the data from the previous longer time period, e.g. two hours. The higher priority is given to the road segments with higher traffic and higher index, i.e. high-traffic and poor road quality. The data source system may be a MEM system (GPS Speed (km/h) and Strut Pressure (kg/cm2)). The vehicle data from every truck 103 on the road segment may be collected every predetermined time period, e.g. two seconds. The length of the road segment may vary for different mines or pits, e.g. 50 m-150 m. The number of critical road segments displayed on the Left pane is configurable per each mine, e.g. max 5 to 10 critical road segments per each zone.

The road segments may be prioritized and color coded as a first color (red), a second color (yellow), and a third color (black) according to their respective Road Quality Score and the number of haul cycles within the last two hours. The prioritization of road segments may be different per mine or pit. The road segment may be marked as Critical (red) if the following criteria are met: Haul cycles >5 and Road Quality Score value >a predetermined threshold, e.g. 50-60.

The road segment may be marked as Concern (yellow) when it is not included in the top 5 or top 10 critical Road Segments, but the following criteria are met: Haul cycles >5 and Road Quality Score value >a predetermined threshold, e.g. 50-60.

If there are less than 5 or 10 critical road segments with road quality score less than the predetermined threshold, then only those road segments may appear as critical.

Each road segment may be marked as Normal (black) if it doesn't have any deviations. If there are no critical Road Segments that match the criteria, then “No Critical Segments” may be displayed on the screen 60.

Similar to shovel position, the dumping of trucks 103 may also be monitored and displayed on the Left pane 61. The dumps may be sorted by the road quality score that is based on a launch speed of an empty truck 103 as it departs from a dump. The launch speed may be calculated for the first predetermined distance, e.g. 200-400 meters, that the empty truck 103 travels from the dump. The current launch speed is compared to a previous time period of data, e.g. an hour of data. If the difference between the current launch speed and an average previous launch speed is more than a predetermined threshold, e.g. 2 km/h, the dump is marked as critical. The source systems of launch speed values may be IODB and MEM (GPS Speed (km/hr)). The data may be collected every predetermined time period, e.g. 1-10 seconds, preferably two seconds.

On the left pane 61, the dumps may be placed between the shovels 101 and the road segments and may be divided into the following two groups: Waste and Stockpile. The dumps may be color coded according to the following criteria. The dump appears as critical, e.g. a first color (red) score on the left pane 61 and the first color (red) label in red circle on the map 62, when the truck launch speed drop is >a predetermined threshold, e.g. 2 km/h. The dump appears as non-critical, e.g. a second color (black) score on the left pane 61 and the blue label in blue circle on the map 62 when the truck launch speed drop is <=the predetermined threshold, e.g. 2 km/h.

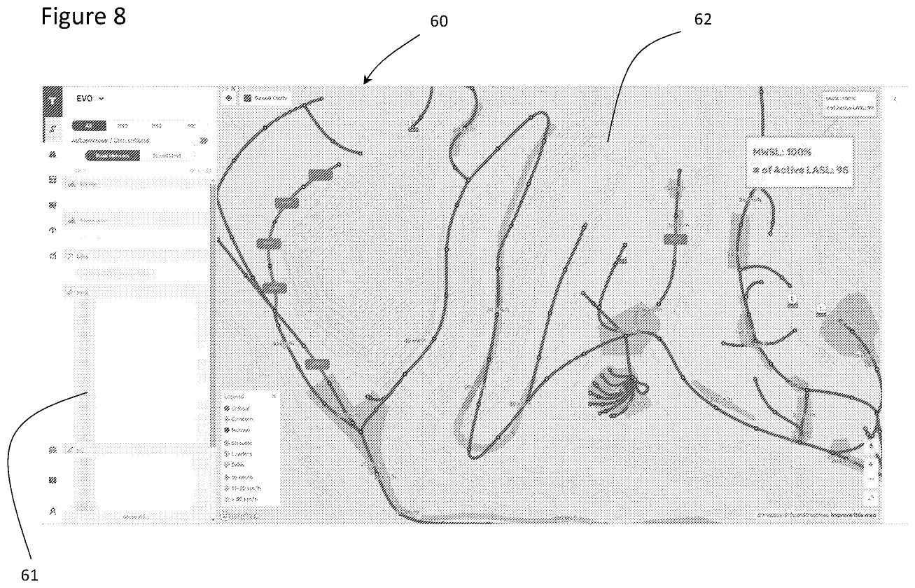

With reference to FIG. 8, for an autonomous haulage systems, in which some or all of the vehicles are autonomous vehicles controlled by one or more remote controllers, the road quality monitoring system 1 may provide a local area speed limit (LASL) system to ensure safety and effectiveness of the trucks 103 depending on the quality of the road. The controllers create and configure speed limit polygons or zones, which may be displayed in the road quality monitoring system 1 on the Haul Analytics page 60. Based on the quality of the road, the controller may change the speed limits for the autonomous trucks 103 to get optimal speed and productivity while minimizing tire wear, fuel cost, and maintenance and safety issues.

A list of the LASL polygons may be located on the left pane 61 by actuating a speed limits tab provided thereon by the road quality monitoring system 1. The unread notifications may be marked with a red dot on the right side. The lines on the left side of each notification may be color coded according to the speed limit area that they refer to. There may be the following notifications for the speed limit polygons: a) creation of the speed limit polygon; b) update of the speed limit or the expiry date of the polygon; and c) expiration of the speed limit polygon.

The speed limits feature on the map 62 may be turned on by default. To turn them off, in the upper-left corner of the map 62, clear the speed limits checkbox. In the lower-left corner of the map 62, a legend provides the color coding for the speed limit polygons. If there is a smaller polygon inside a bigger one, the smaller polygon uses the local speed limit instead of the speed limit of the bigger polygon.

On the map 62, e.g. upper-right corner, a Mine Wide Speed Limit (MWSL) information may be displayed. The MWSL label on the map 62 indicates the percentage of the maximum speed that the trucks 103 may develop on the areas that are not covered with the speed limit polygons. This information supplements the Local Area Speed Limits feature to help decide whether to increase the Mine Wide Speed Limit, thus optimizing Truck productivity versus tire wear and fuel efficiency. Under the MWSL label, the #of Active LASL label may show the number of currently active speed limit polygons.

When a speed polygon is selected by the user, the LASL system configures the right pane with some or all of the following information to open: a) full polygon ID; b) Current speed limit—the speed limit for the polygon; c) Created or Updated—the date when the speed limit was created or updated; and d) Expiry—the date when the speed limit expires and the email of the controller who edited it. Notifications about the selected polygon may also be configured.

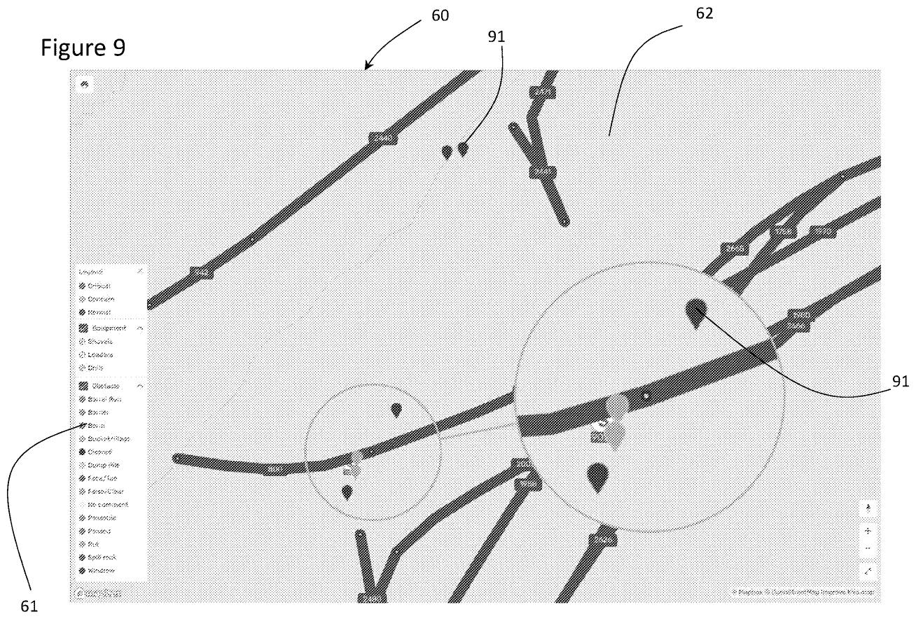

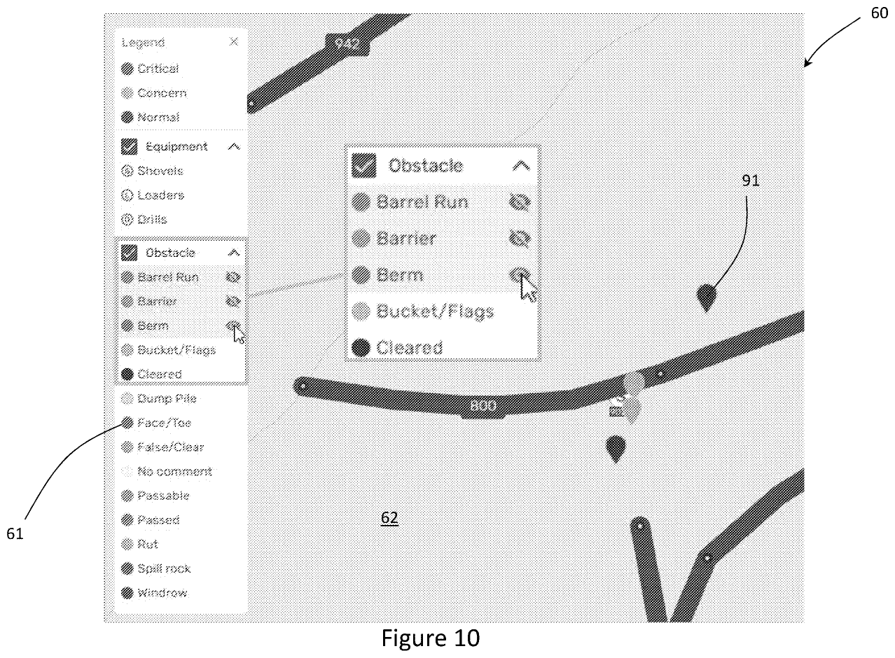

With reference to FIGS. 9 and 10, obstacles on the road can delay the trucks 103 for a considerate amount of time, e.g. the obstacle number varies from 25 to 200 with the daily average of ˜75. The road quality monitoring system 1 may include a table or database of obstacles that may be populated and updated by Crews in the mine or pit. Alternatively, a separate application may be used, such as a fleet management system containing a data table that stores obstacle detection events, e.g. timestamp, machine ID, user comments, and clear timestamp. The obstacles may be added to the table by the Crews in the mine or pit, and the Road Quality application may use this data to show the obstacles on the map 62. An obstacle detection functionality on the map 62 may be used to perform a root cause analysis of the previously cleared obstacles, so that they can be avoided in future.

There may be a coding system for every obstacle event and its location. After controllers clear an obstacle or confirm that the obstacle has been cleared, they may put a 4-digit code into the obstacle database. The first 2 digits of the code may be the location ID and the last 2 digits may be the obstacle ID. Each obstacle ID may correspond to a certain color that is marked with on the map.

On the Haul Analytics page 60, the data related to obstacles may update at predetermined time intervals, e.g. every 10 min. Obstacles appear as pinpoints 91 on the map 62 according to their coordinates; and may not related to road segments and other units. Every obstacle may be displayed on the map for at least 24 hours. If two or more obstacles have the same coordinates, they may be displayed in slightly different positions. If several obstacles are located close to each other, they may form a cluster on the map 62. To see such obstacles separately from each other, a zoom button, e.g. in the bottom-left corner of the map 62, may be used to zoom in.

When you select an obstacle 91 on the map 62, the road quality monitoring system 1 may display a tooltip with the following information: a) full obstacle type name; b) truck delay time in minutes; and c) time when the obstacle was detected and registered.

With reference to FIG. 10, on the map Legend (left pane 61), all the obstacle types may be listed with their corresponding color coding. Both Equipment and Obstacle sections may be enabled and expanded by default. A needed section may be enabled or disabled by clearing or selecting the corresponding checkbox next to it. When the Equipment section is disabled, the Shovels list may also disappear from the Left pane 61. Each equipment or obstacle type may be hidden or shown by selecting the a predetermined icon next to it.

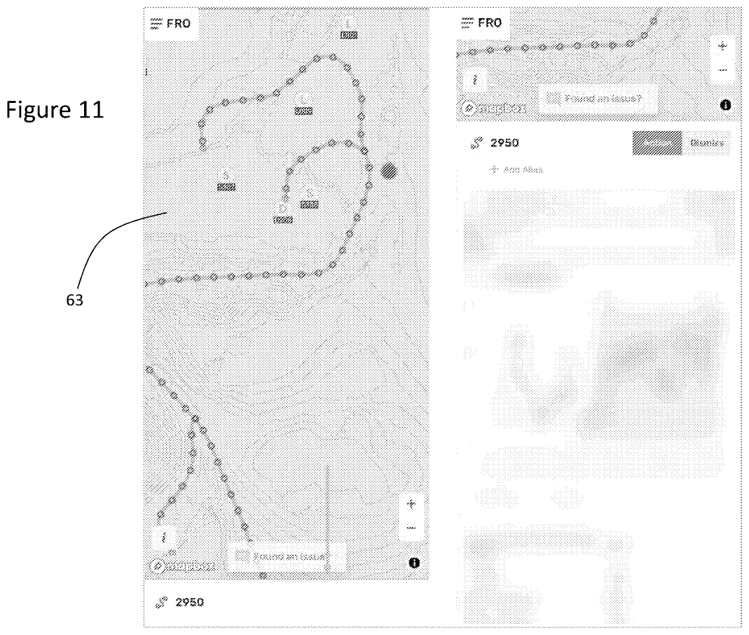

With reference to FIG. 11, the metrics pane 63 may be displayed by the road quality monitoring system 1, when a Road Segment, a Shovel, or a Dump is selected on the left pane 61 or the map 62. The information and options available on the metrics pane 63 may be different for Road Segments, Shovels, and Dumps. On the metrics pane 63, the road quality monitoring system 1 may be configured to enable one or more of the following: a) Add, edit, or delete Alias from the Road Segment; b) Add or edit Action for Road Segment or Shovel; c) Revert Action for Road Segment or Shovel; and d) Dismiss Road Segment or Shovel alert.

For Road Segments, the metrics pane 63 may provide some or all of the following information:

1. The Road Segment ID with a color coded icon that reflects the status of the Road Segment, e.g. Red when the Road Segment is labeled as Critical, (Road Quality score >=target and number of cycles is >threshold, e.g. 5; Yellow when road segment is labeled as Concern (Road Quality score >=target and number of cycles is >threshold, e.g. 5; and Black when the road segment is labeled as Normal (score <=target and number of cycles is <=threshold, e.g. 5).

2. Grade—the information about the elevation on the road segment. The Grade value is calculated by using a standard haulage model (SHM) Surface and x, y, and z coordinates of the beginning and ending of the road segment. The absolute value of the Grade may always be positive, for example, 7.0% or 3.5%. The grade values may be received from the map, e.g. GeoJSON, file and may be rounded to 1 decimal point. If there is no data for Grade, then a dash “-” appears. The grade may be calculated when generating the road network file. The color coding of Grade values may differs per Mine and works this way: when Grade >=predetermined level, e.g. 8%-10% preferably 9%—red, <predetermined level—green.

3. Score—the Road Quality Score of the Road Segment. The value is similar to the value in the Unit list on the Left pane 61.

4. Road Quality Chart and Speed Loaded/Empty Chart. The two charts display the last calculated values. Switching between the charts may be possible by selecting their respective tabs. For each chart, the visual start of the new shift is displayed. The schedule of shifts may be configured differently for each Mine.

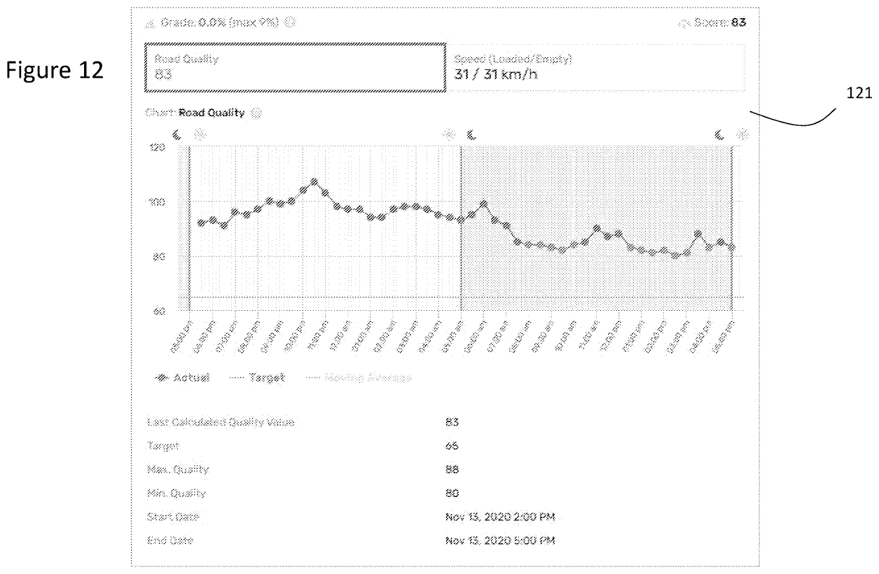

With reference to FIG. 12, the road quality chart 121 may display one or more of the curves: a) Actual—the actual road quality score on the selected road segment over time, the curve is enabled by default. The road quality Score values are visualized as color coded points (green, yellow, and red), and may be updated at regular time intervals, e.g. half hourly updates; b) Target—the target (threshold) value of the Road Quality Score that is configured for the given Mine; and c) Moving Average—the average speed on the selected road segment.

Under the road quality chart 121, a table may be displayed with some or all of the following data: a) Last Calculated Avg Quality Value for the selected Shovel (measured in kg/cm²); b) Target Score for the Road Segment for the given Mine (measured in kg/cm²); c) Max. Quality stands for the maximum Road Quality Score within the last two hours; d) Min. Quality stands for the minimum Road Quality Score within the last two hours; and e) Start Date and End Date (period between start and end date or time equals two hours).

The Road Quality value in the Metrics pane 63 may equal the last point on the road quality chart 121 and the last calculated avg quality value in the details list. Also, the road quality value may be the same as the road quality Score value on the left pane 61.

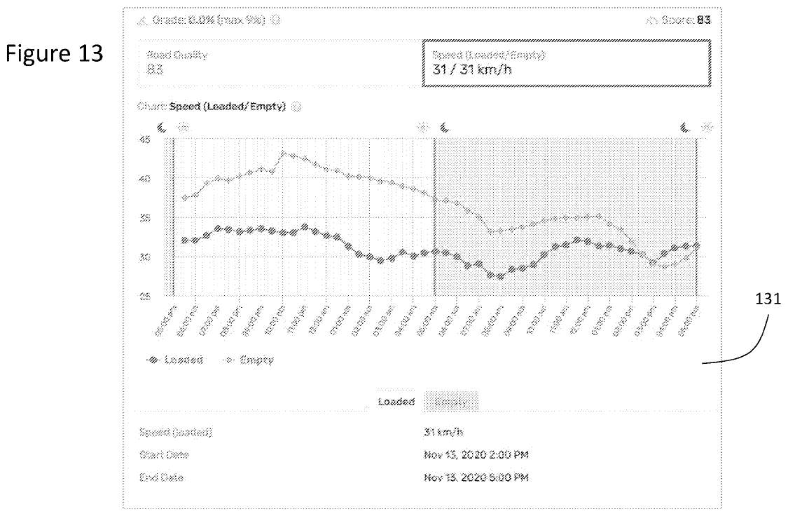

With reference to FIG. 13, the speed loaded/empty chart 131 may have plots for Speed Loaded and/or Speed Empty Truck speed. The Average Speed metric measures the speed of loaded and empty Trucks. The metric may rely on information from one or more MEM systems and fleet management systems. Data for the last predetermined time period, e.g. 24 hours, may appear on the speed loaded/empty chart 131.

Speed Empty is the average speed of the empty trucks 103 as they pass through a road segment within the last predetermined time period, e.g. one to 5 hours, preferably three hours. The source system may be a MEM system, which may provide the GPS speed in km/h that is collected at predetermined time intervals, e.g. every 1-10 seconds, preferably every two seconds.

Speed Loaded is the average speed of the loaded trucks 103 as they pass through a road segment within the last predetermined time period, e.g. one to five hours, preferably three hours. The source system may be a MEM system, which provides the GPS speed in km/h that is collected at predetermined time intervals, e.g. every 1-10 seconds, preferably every two seconds.

Under the speed loaded/empty chart 131, details for Speed Loaded and Speed Empty may be displayed. Some or all of the following details may be included: a) The Speed of the loaded or empty Truck measured in km/h; and Start Date and End Date (period between start and end date or time equals three hours).

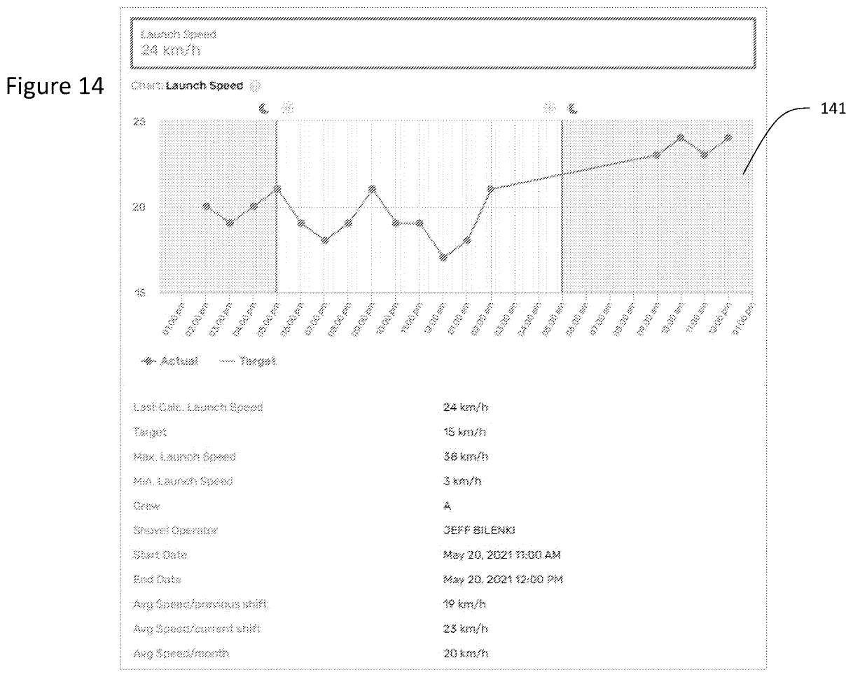

With reference to FIG. 14, for Shovels, the Metrics pane 63 may provide the Shovel ID and the Launch Speed chart 141. The Shovel ID has a color coded icon that reflects the status of the Shovel, e.g. Red when the Shovel is critical (launch speed drop is >2 km/h); and Black when the Shovel is non-critical (launch speed drop is <=2 km/h). Launch Speed may be the speed of a loaded truck 103 during an initial distance, e.g. the first 100-400 meters, preferably the first 150-200 meters after its departure from a shovel 101. The distance and speed may calculated by using GPS speed in km/h from one or more MEM systems and fleet management systems.

In this way, the road quality monitoring system 1 may follow the actual route of the truck 103 instead of using the 150 meter radius around a shovel 103. The GPS data from the truck 103 may be collected at regular time periods, e.g. 1-5 seconds, preferably every two seconds. This metric may be calculated based on the meters the hauling unit needs to travel before it reaches ideal speed after departing from the shovel 103.

The Shovel ID and the Launch Speed chart 141 on the metrics pane 63 may include curves for Actual and Target Launch Speed. The Target curve stands for an ideal launch speed, e.g. 15 km/h, of a truck 103. The hourly updates on the speed are visualized as points. Hovering over the point may enable the road quality monitoring system 1 to display more details, including: a) Average Truck Launch Speed as it departs from the selected Shovel; b) Time when the launch speed value was calculated; c) Number of Haul Cycles within the last hour; d) Crew operating at the selected Shovel 101; and e) Name of the Operator of the selected Shovel 101.

The road quality monitoring system 1 may also be configured to display, e.g. under the Launch Speed chart 141, a table with at least some of the following data: a) Last Calculated Launch Speed Value for the Trucks 103 departing from the selected Shovel 101; b) Target value of the Truck launch speed; c) Max. Launch Speed of the Trucks 103 within the last hour; d) Min. Launch Speed of the Trucks 103 within the last hour; c) Crew that is working with the selected Shovel 101; f) Name of the Shovel Operator who is currently working with the Shovel 101; g) Start Date and End Date (period between start and end date or time equals two hours); h) Avg Speed of the Trucks 103 for the previous shift; i) Avg Speed of the Trucks 103 for the current shift (updated every hour); and j) Avg Speed of the Trucks 103 for the last month.

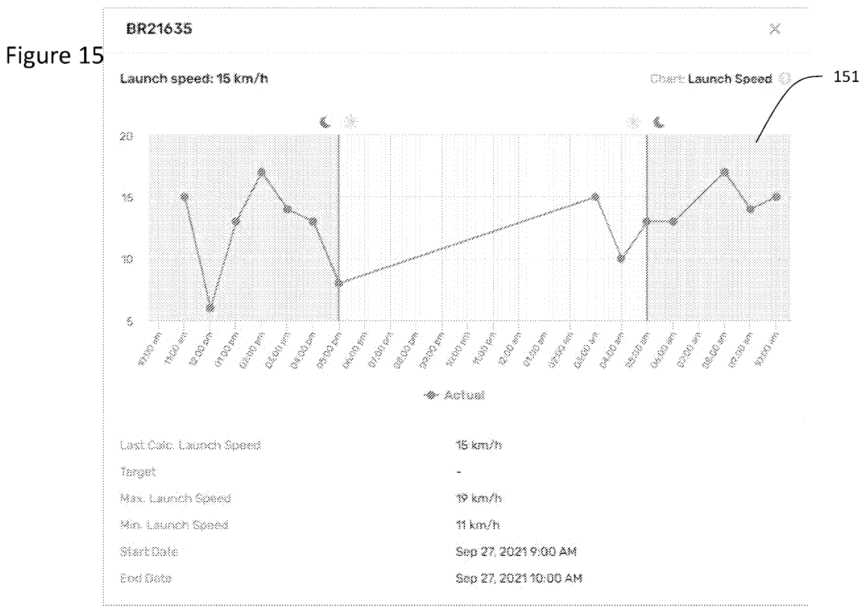

With reference to FIG. 15, the metrics pane 63 may provide, a Dump ID, a road quality Score, and a dump Launch speed chart 151. The Launch Speed may be the speed of an empty truck 103 after its departure from a dump, e.g. during the first 300 meters. The distance and speed may be calculated by using GPS speed in km/h from the IODB and MEM systems. In this way, the application can follow the actual route of the Truck 103 instead of using the 300 meter radius around a Dump. The GPS data from the Truck may be collected at predetermined time intervals, e.g. every two seconds. This metric may be calculated based on the meters the hauling unit needs to travel before it reaches ideal speed after departing from the Dump.

The dump launch speed chart 151 may include the Actual Launch Speed curve including several points, e.g. truck speed at an actual time. Hovering over the points may enable the road quality monitoring system 1 to display more details, including: a) Average Truck Launch Speed as it departs from the selected Dump; b) Time when the launch speed value was calculated; and c) Number of Haul Cycles within the last time period, e.g. hour.

The road quality monitoring system 1 may also be configured to display, e.g. under the dump Launch Speed chart 151, a table with some or all of the following data: a) Last Calculated Launch Speed Value for the selected truck 103 departing from the selected Dump; b) Target speed of selected truck 103 is currently not set and will be defined using the empiric method. When the target value is defined, the corresponding curve will be added to the chart; c) Max. Launch Speed of the truck 103 within the last hour; d) Min. Launch Speed of the truck 103 within the last hour; and Start Date and End Date (period between start and end date or time equals two hours).

When an Action is taken or a road segment or shovel alert is dismissed, they mall be recorded in a History Log and displayed on the Metrics pane 63. The History Log of a Road Segment or a Shovel, may be displayed by selecting the road segment of the shovel on the left pane 61. The history of the road segment or shovel may appear under the item ID.

Details about the Actions taken towards and dismissals of Road Segment and Shovel alerts may be updated in real time. For each Action, the History Log may contain some or all of the following information: 1. Status icon—Taken, In Progress, Planned, or Dismissed; 2. Crew that works when the Action starts. For all Actions, the Crew may be defined by a Start Date. For Planned Action, the Crew may be assigned according to the schedule; 3. Action type or dismissal reason; 4. Comments (if available); 5. Start and end dates of Action or dismissal; and 6. Editing options—Edit and Revert for Actions taken and Revert for dismissals that appear by selecting.

There may be primary and secondary sorting of Actions in the History Log. Primary sorting is based on the priority of the Action status, e.g. a) In progress Actions have the highest priority; b) Planned Actions have the middle priority; c) Taken Actions have low priority; and d) Dismissed alerts have the lowest priority. Secondary sorting works within each group of Actions and it is based on the start date (from the latest to the earliest). The two last Actions of the highest priority appear in the History Log. The Action status label may disappear from the Left pane 61 and the Metrics pane 62 when the Action end date or time is more than a predetermined time limit, e.g. 24 hours to 7 days.

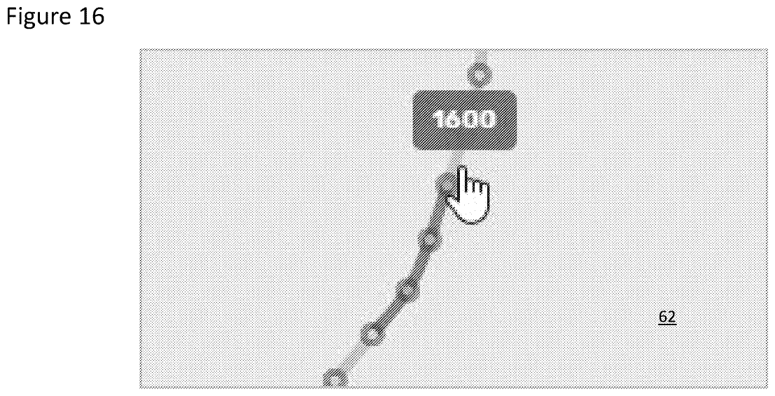

With reference to FIG. 16, any end user, e.g. supervisor 112, may add any number of Actions for critical and non-critical Road Segments and Shovels. Later, an Actions Report may be displayed to check and prove the effectiveness of adjustments to the mine supervisors 112. The selected Road Segments may be highlighted on the map 62. To add an Action: 1. On the Left pane 61, select the needed Road Segment or Shovel; 2. On the Metrics pane 63 on the right side, select Action; then 3. In the dialog box that opens, fill in the following fields:

a) Segment(s) (optional)—up to 10 Road Segments may be added for the same Action. To add more Road Segments: Enter the ID of a Road Segment or select it from the suggestion list. By default, the current Road Segment ID is selected.

b) Action Type—select the option from the drop-down menu.

For Road Segments, there may be one or more of the following Action Types: a) Fix Grade; b) Add Illumination; c) Check for Speed Drop; d) Repair Road; and e) Ditching

For Shovels, there are the following Action Types: a) Adjust Trailing Cable or Stands; b) Floor Cleanup; c) Improve Heading (Direction, Width, etc.); and d) Reduce Congestion.

c) Start Date and End Date—select the start and end dates of the Action. By default, current date and time may be selected. The Crew may be assigned to the Action according to the Start Date.

d) Period—select the Action duration in hours (if applicable). select the period of one, two, three hours, and the end of shift. When you select a period, the time and date in the End Date field may be automatically updated. If you select the future date in the End Date field, the Period is updated to Custom.

e) Comment (optional)—enter the commentary if necessary (max 300 characters).

When the Action is saved, an icon is added to the Road Segment or Shovel on the Left pane 61. The icons correspond to the following statuses: a) Planned—the Action starts and ends in the future; b) In progress—the Action started in the past and ends in the future; and c) Taken—the Action started and ended in the past.

A Repair Schedule table may be generated and displayed, illustrating the details for every recommendation that was provided by the controller processor 2 over the selected period of time. The table may include one of more of the following columns: a) Shift date—the date of the Crew shift when the Road Segment was recommended for repairs; b) Shift alias—D stands for day shift and N stands for night shift; c) Zone—the Pit or Zone of the Mine where the Road Segment is located; d) Segment—the ID of the Road Segment that was recommended for repairs; e) Length (ft for RDO and m for all the other Mines)—the length of the Road Segment that was recommended; f) Crew—the names of the Crews that worked during the shift in question; g) Score—the Road Quality Score aggregate for the last 24 working hours. The rows of the table may sorted from the newest to the oldest by default.

An Average Speed Change per Repair table may also be generated and displayed on an Impact Tracker page based on how the repairs of Road Segments by Crews affected the speed of the rucks 103. Each column in the table may stand for the speed of the trucks 103 some hours or days after the Crew repaired the Road Segment, e.g. 3 hrs, 6 hrs, 12 hrs, 24 hrs, 2 days, 3 days, 4 days, 5 days, 6 days, and 7 days.

By default, the Crews may be sorted in ascending order by their names. The table may also include Average and Total values. The Average value counts as arithmetic mean of all Crews if value is 0 or bigger. If there's no data for the Crew, then it's not included into the calculation of the Average. For example, if Crew A had 5 Actions, Crew B had 0 Actions, Crew C had “-” Actions, and Crew D had 1 Action, then the Average will be (5+0+1)/3=2. If the Crew didn't work at that time or the data was not calculated, the dash “-” is displayed instead of values in the column. If there was a speed decrease, the negative values are filtered out.

Measured hours—the Impact Tracker page data may be based on measuring the difference in average Truck speed N hours before and after the Road Segment is repaired. Measured hours defines the N number of hours before and after an Action is taken towards a Road Segment. The data registered during the measured hours period is used to compare the speed of Trucks, the number of Truck passes, and other metrics in the table.

Average speed (full & empty)—this section may provide details about the average speed of all full and empty Trucks 103 passing through the repaired Road Segment. This section may include one or more of the following columns:

Before repair—the average speed of Trucks before the Road Segment was repaired. The value is calculated for the N hours before the Road Segment Action; the number of hours is indicated in the Measured hours column (for example, 3 hrs, 24 hrs, 96 hrs.)

After repair—the average speed of Trucks after the Road Segment was repaired. The value is calculated for the N hours after the Road Segment Action; the number of hours is indicated in the Measured hours column (for example, 3 hrs, 24 hrs, 96 hrs.)

Expected after repair—the average speed of Trucks after Road Segment repair that is predicted by the Road Quality application based on a formula.

Delta—the actual Truck speed change of the Road Segment (calculated as delta between the After repair and Before repair values.)

Delta—the measure of inaccuracy in the prediction of the Truck speed (calculated as delta between the After repair and Expected after repair values.)

Variance %—the increase of Truck speed in percentage compared to the speed before the repair.

Variance %—the measure of inaccuracy between the predicted and real Truck speed in percentage.

Truck passes—the number of Truck passes through the repaired Road Segment.

Before repair—the number of Truck passes that were registered N hours before the repair (the measured hours value is used.)

After repair—the number of Truck passes that were registered N hours after the repair (the measured hours value is used.)

Delta—the delta of Truck passes that were registered for N hours before and after the repair (the Measured hours value is used.)

Variance %—the variance in number of Truck passes in percentage before and after the Road Segment was repaired.

TTS—this section may provide details about the total time that was saved due to the Actions that were performed by the Crews. The values are calculated according to the SHM model. The TTS can be positive when the Truck speed increased and the hours were saved, or negative when the Truck speed decreased and the balance of saved hours is negative. The accuracy of this metrics depends on the number of Truck passes (that is, the less Truck passes there are registered, the less accurate the metrics is.)

Hours—the actual number of Truck hours that were saved due to the repairs performed by the Crews.

Hours—the number of Truck travel hours saved as predicted by the application.

Neg (hrs)—the TTS prediction is calculated before and after the Road Segment is repaired. The value in this column is a ratio of the predicted TTS values that were calculated before and after the Crew repaired the Road Segment, where the smallest value is used.

Neg (hrs)—the ratio of the predicted TTS values before and after the Crew repaired the Road Segment, where the biggest value is used. In conjunction with the previous Neg (hrs) column, this creates a range of the TTS value prediction.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. A method of monitoring road quality in a mining operation performed by a plurality of different types of vehicles including a plurality of trucks travelling a plurality of roads, the method comprising:
a) receiving vehicle operation data from the plurality of trucks, the vehicle operation data comprising strut pressure data and location data from the plurality of trucks;
b) dividing the plurality of roads into a plurality of road segments;
c) determining a road quality score based on the strut pressure data for a plurality of road segments;
d) displaying the plurality of roads on a map;
e) displaying road segments with the road quality score above a predetermined threshold value differently than road segments with the road quality score below the predetermined threshold value.

2. The method according to claim 1, wherein the road quality score is also based on a number of times the road segment is travelled by the plurality of trucks.

3. The method according to claim 2, wherein the road quality score is 0 when the number of times the road segment is travelled is below a travel threshold.

4. The method according to claim 1, wherein the road quality score is based only on strut pressure data from trucks with at least a 50% load.

5. The method according to claim 1, wherein the road quality score is based only on strut pressure data from rear axles of the plurality of trucks.

6. The method according to claim 1, wherein the road quality score is based on strut pressure data normalized for truck speed.

7. The method according to claim 1, wherein the road quality score is based on strut pressure data normalized for different types of trucks and strut pressure sensors.

8. The method according to claim 1, wherein the road quality score is based on a mean road quality score over a given period of time.

9. The method according to claim 1, wherein the road segments with the road quality score above a predetermined threshold value are displayed in a first color, while the road segments with the road quality score below the predetermined threshold value are displayed in a second different color.

10. The method according to claim 1, wherein in step a) the vehicle operation data also includes velocity of the plurality of trucks; and
wherein step c) also comprises determining a road quality score based on launch speeds of the plurality of trucks from a stop.

11. The method according to claim 10, wherein the launch speed is determined within an initial 200-400 meters from the stop.

12. The method according to claim 10, wherein step e) also includes displaying road segments with a current launch speed different than an average previous launch speed by more than a predetermined threshold differently than road segments with a current launch speed different than an average previous launch speed by less than the predetermined threshold.

13. The method according to claim 12, wherein the predetermined threshold is 2 km/h.

14. The method according to claim 1, further comprising displaying obstacles on the map.

15. The method of claim 1, further comprising removing vehicle operation data from outlier vehicles.

16. The method according to claim 15, wherein the outlier vehicles comprise trucks that produced less records than a daily threshold during the past predetermined time period.

17. The method according to claim 15, wherein the outlier vehicles comprise trucks that produced average daily strut pressure data outside of a predetermined range.

18. The method according to claim 15, wherein the outlier vehicles comprise trucks of a make or model that is not a selected make or model.

19. The method according to claim 1, wherein the plurality of trucks include at least one autonomous truck; and further comprising providing a local area speed limit (LASL) system based on the road quality scores in the local area.

20. The method according to claim 1 wherein each road segment is 50 m to 250 m in length.

21. A system for measurement of a road network in a mine, comprising:
a plurality of sensors installed at each of a plurality of vehicles on the road network and configured to acquire a sequence of suspension loading records for each of said plurality of vehicles, each comprising positioning coordinates of the vehicle and a measurement of load on vehicle suspension at a point in time;
a processing device configured to:
for each of said plurality of vehicles:
receive said sequence of suspension loading records;
detect variations in said load between ones of said sequence of suspension loading records; and
associate each of said variations with one of a plurality of segments of said road network based on said positioning coordinates; and
determine a road quality measurement representative of a condition of said segment based on said variations; and
output on a user interface a graphical representation of said road network, said graphical representation including visual indicators of segments to be repaired.

22. The system of claim 21, wherein said measurement of load comprises a pressure in a vehicle strut.

23. The system of claim 21 or 22, wherein said processing device is configured to detect variations by computing a load on a rear suspension and compute a difference in said load on a rear suspension between successive suspension loading records.

24. The system of any one of claims 21 to 23, wherein said processing device is configured to compute a vehicle-adjusted variation for each of said variations based on characteristics of the respective vehicle, and to determine said road quality score using the vehicle-adjusted variation.

25. The system of any one of claims 21 to 24, wherein said processing device is configured to compute a velocity-adjusted variation for each of said variations based on a measured velocity of the respective vehicle, and to determine said road quality measurement using the velocity-adjusted variation.

26. The system of claim 25, wherein said processing device is configured to compute said velocity-adjusted variation by computing a normalized velocity and subtracting said normalized velocity from said variation.

27. The system of any one of claims 21 to 26, wherein said processing device is configured to define a plurality of segments of said road network by dividing said road network into segments of a desired length.

28. The system of claim 27, wherein said processing device is configured to define said plurality of segments by plotting paths between road beacons using a smoothing algorithm.

29. The system of any one of claims 21 to 28, wherein said processing device is configured to compute a count of traffic on each said plurality of segments.

30. The system of claim 29, wherein said processing device is configured to compute a quality score for each of said plurality of segments, said quality score based on said road quality measurement and said count of traffic, and said quality score for each segment representing a priority for that segment to be repaired.

31. The system of claim 30, wherein said processing device is configured to output on said user interface visual indicators of said quality scores for said segments.

32. A method for measurement of a road network in a mine, comprising:
obtaining a sequence of suspension loading records for each of a plurality of vehicles on the road network, each suspension loading point comprising positioning coordinates of the vehicle and a measurement of load on vehicle suspension at a point in time;
for each of said plurality of vehicles:
receiving said sequence of suspension loading records;
detecting variations in said load between ones of said sequence of suspension loading records; and
associating each of said variations with one of a plurality of segments of said road network based on said positioning coordinates; and
determining a road quality measurement representative of a condition of said segment based on said variations; and
outputting on a user interface a graphical representation of said road network, said graphical representation including visual indicators of segments to be repaired.

33. The method of claim 32, wherein said measurement of load comprises a pressure in a vehicle strut.

34. The method of claim 32 or 33, comprising detecting variations by computing a load on a rear suspension and computing a difference in said load on a rear suspension between successive suspension loading records.

35. The method of any one of claims 32 to 34, comprising computing a vehicle-adjusted variation for each of said variations based on characteristics of the respective vehicle, and determining said road quality score using the vehicle-adjusted variation.

36. The method of any one of claims 32 to 35, comprising computing a velocity-adjusted variation for each of said variations based on a measured velocity of the respective vehicle, and determining said road quality measurement using the velocity-adjusted variation.

37. The method of claim 36, wherein comprising computing said velocity-adjusted variation by computing a normalized velocity and subtracting said normalized velocity from said variation.

38. The method of any one of claims 32 to 37, comprising defining a plurality of segments of said road network by dividing said road network into segments of a desired length.

39. The method of claim 38, comprising defining said plurality of segments by plotting paths between road beacons using a smoothing algorithm.

40. The method of any one of claims 32 to 39, comprising computing a count of traffic on each said plurality of segments.

41. The method of claim 40, comprising computing a quality score for each of said plurality of segments, said quality score based on said road quality measurement and said count of traffic, and said quality score for each segment representing a priority for that segment to be repaired.

42. The method of claim 41, comprising outputting on said user interface visual indicators of said quality scores for said segments.
